(19) United States
(12) Patent Application Publication
(10) Pub. No.: US 2013/0303695 A1
(43) Pub. Date: Nov. 14, 2013

(54) HYALURONIC ACID-CONTAINING BIOPOLYMERS

(71) Applicants: Heather Sheardown, Nobleton (CA); Andrea Weeks, Hamilton (CA); Lyndon Jones, Waterloo (CA); David Morrision, LOndon (CA); Johan Alauzun, Montpellier (FR)

(72) Inventors: Heather Sheardown, Nobleton (CA); Andrea Weeks, Hamilton (CA); Lyndon Jones, Waterloo (CA); David Morrision, LOndon (CA); Johan Alauzun, Montpellier (FR)

(21) Appl. No.: 13/820,177

(22) PCT Filed: Sep. 2, 2011
(86) PCT No.: PCT/CA2011/000996

§ 371 Date: Jun. 26, 2013

Related U.S. Application Data
(60) Provisional application No. 61/379,499, filed on Sep. 2, 2010.

(51) Int. Cl. C08F 220/28

(52) U.S. Cl. CPC C08F 220/28
USPC 525/54.2

(57) ABSTRACT

Novel hyaluronic acid-containing biopolymers are provided which exhibit increased hydrophilicity and reduced protein adsorption. In one aspect, the biopolymer incorporates hyaluronic acid modified to include a linking agent in a molar excess sufficient to yield a degree of HA modification in a range of about 1-5. In another aspect, the biopolymer incorporates unmodified hyaluronic acid.

### FIELD OF INVENTION

The present invention relates to hyaluronic acid-containing biopolymers, and methods for making such biopolymers.

### BACKGOUND OF INVENTION

Despite the success of both conventional and silicone hydrogel soft contact lenses, sorption of tear film proteins (lysozyme and albumin) onto the surface or into the matrix of these lenses remains a problem. This can lead to decreased comfort and ultimately discontinuation of lens wear. The presence of protein deposits on the surface of contact lenses is also believed to contribute to the development of secondary complications including giant papillary conjunctivitis. Factors influencing protein sorption include lens hydrophilicity, water content, surface charge, as well as the nature of the polymers comprising the contact lens and the nature of the adsorbing proteins. Hydrophilic lens surfaces have been shown to decrease protein sorption. Therefore, improving hydrophilicity In contact lens materials is of interest to reduce protein sorption and improve user comfort.

Hyaluronic acid (HA) is a natural, non-toxic, hydrophilic, glycosaminoglycan that is found in the vitreous humour of the eye, the cartilage of the knee as well as in the synovium. The properties of HA have made it an ideal polymeric biomaterial in such applications as drug delivery and tissue engineering. In the eye, HA has been investigated in the treatment of dry eye, in drug delivery, and as a viscosupplement in cataract surgery. HA has been previously demonstrated to improve hydrophilicity, reduce lysozyme sorption and decrease denaturation of deposited lysozyme when incorporated as an internal wetting agent using dendrimers for linking in model conventional and silicone contact lens materials [van Beek et al. Biomaterials 2008; 29:780-9; van Beek et al. Journal of Biomaterials Science, Polymer Edition 2008; 19(11):1425-36.]. In these previous studies, HA was incorporated into the materials via amine groups of dendrimers using EDC chemistry. However, in addition to introducing dendrimers into the lens materials which may negatively impact in vivo biocompatibility, this method is time consuming and requires post-modification of the lens materials. Several different methods for crosslinking HA have also been used using adipic dihydrazide and aldehyde chemistry; however, these methods also involve post-modifications which are time-consuming. Additionally, it has been shown that when HA is used as a releasable wetting agent, the majority of the HA is released within the first 24 hrs with minimal sustained release

Therefore, it would be desirable to develop a method of incorporating HA into a biomaterial to yield a product which provides advantageous properties.

### SUMMARY OF THE INVENTION

Novel hyaluronic acid-containing biopolymers are provided, and a one-step method of preparing such biopolymers.

In one aspect of the invention, a hyaluronic acid-containing biopolymer is provided in which the hyaluronic acid is modified to incorporate a linking agent in a molar excess sufficient to yield a degree of HA modification in a range of about 1-5, and preferably, about 2-3.

In another aspect of the invention, a biopolymer containing hyaluronic acid having a molecular weight in the range of about 30,000-200,000 kDa is provided, wherein the hyaluronic acid is releasably contained within the biopolymer.

In a further aspect of the invention, a one-step method of making a hyaluronic acid-containing biopolymer is provided comprising admixing HA with a biopolymer-forming solution under conditions suitable to effect polymerization.

These and other aspects of the invention are described by reference to the detailed description with reference to the figures.

### BRIEF DESCRIPTION OF THE FIGURES

FIG. 1 is a schematic illustrating the HA methacrylation reaction and the resulting methacrylated HA structure;

FIG. 2 is a schematic illustrating the effects of HA methacrylation on HA mobility and crosslinking;

FIG. 3 graphically illustrates the mean advancing water contact angles (AWC) of pHEMA hydrogels;

FIG. 4 graphically illustrates the mean advancing water contact angles (AWC) of pHEMA/TRIS hydrogels;

FIG. 5 graphically illustrates the mean advancing water contact angles (AWC) of DMAA/TRIS hydrogels;

FIG. 6 graphically illustrates the mean equilibrium water content (EWC) of pHEMA hydrogels;

FIG. 7 graphically illustrates the mean equilibrium water content (EWC) of pHEMA/TRIS hydrogels;

FIG. 8 graphically illustrates the mean equilibrium water content (EWC) of DMAA/TRIS hydrogels;

FIG. 9 graphically illustrates the mean lysozyme sorption onto pHEMA hydrogels; and

FIG. 10 graphically illustrates the mean lysozyme sorption onto pHEMA/TRIS and DMAA/TRIS hydrogels.

### DETAILED DESCRIPTION

Novel hyaluronic acid-containing biopolymers, and methods of making such biopolymers, are provided. The biopolymers advantageously exhibit increased hydrophilicity, both surface hydrophilicity and bulk hydrophilicity, as well as low levels of protein deposition.

Hyaluronic acid (HA), also known as “hyaluronan” or “hyaluronate” is a glycosaminoglycan. In particular, it is a polymer of disaccharides composed of D-glucuronic acid and D-N-acetylglucosamine, linked together via alternating beta-1,4 and beta-1,3 glycosidic bonds. Polymers of hyaluronic acid can range in size from 1 to 10⁶ kDa in vivo. For the purposes of the present invention, HA of lower molecular weights, for example, between 1 and 200 kDa, are employed to prepare the present HA-containing polymers. Preferably, HA having a molecular weight of about 1 to 40 kDa is employed.

The term “biopolymer” is used herein to encompass polymers which are biocompatible and suitable for use with living tissue, in vitro and in vivo, and thus are suitable for use in biomedical applications. Accordingly, biopolymers for use in the present invention will not be toxic or otherwise unsuitable for such use. Examples of suitable biopolymers include polymers used in contact lenses, pacemaker leads and intraocular lenses including, but not limited to, acrylic-based polymers such as methyl methacrylate, poly (hydroxyethyl methacrylate) (pHEMA), poly N-isopropyl acrylamide, polyacrylic acid; polyurethanes and polyurethane ureas; silicone polymers (poly (dimethyl siloxane polymers)) including copolymers of methacryloxy propyl tris (trimethylsiloxy) silane (TRIS) and acrylic-based polymers such as pHEMA comprising various amounts of TRIS varying from about 1% to 99% TRIS; other hydrogel polymers including polyvinyl alcohol and biopolymers such as collagen.

For the purposes of the present invention, the term “HA-containing biopolymer” refers to a biopolymer which contains mobilized HA, e.g. HA which is associated with the biopolymer such that it is at least able to migrate through the biopolymer. Preferably, mobilized HA is achieved by utilizing linker-modified HA which has a low degree of linker modification to result in limited points of attachment of the HA to the biopolymer, e.g. no more than about 1-5 points of attachment per HA and preferably, 1-3 points of attachment. Degree of HA modification refers to the number of linkers added to an HA polymer.

The present HA-containing biopolymers may be prepared using a one-step method in which linker-modified HA, e.g. HA modified to include a linking agent which functions to link HA to the biopolymer, is combined with a biopolymer-forming solution. Linker-modified HA may be prepared by combining a solution of HA with a linking agent to render linker-modified HA that is appropriate to generate an HA-containing biopolymer. Linking agents suitable for this purpose include any molecule that possesses a functional group suitable to form a linkage with HA, e.g. such as a covalent linkage, and which will also form an attachment with a target biopolymer. Suitable linking agents include those, for example, which are activated by light using an appropriate initiator Examples of such linking agents include, but are not limited to, acrylic anhydride, methacrylic anhydride and methacrylate.

Once a suitable linking agent is selected, it is admixed with an HA solution under conditions suitable to facilitate attachment of the linking agent to the HA. Generally suitable conditions are well-established in the art and include conducting the reaction in an ice bath for a period of about 1-2 days and maintaining the solution at a slightly basic pH. The amount of linking agent used will depend on the molecular weight of the HA, but is adjusted to achieve the desired degree of modification. Generally, a molar excess of not greater than 20 times linking agent to HA is utilized, preferably not more than 10 times, and more preferably not greater than 5 times, e.g. not greater than 1-2 times linking agent to HA may be utilized to yield HA having a degree of modification in a range of about 1-5, preferably 2-3.

To form the HA-containing biopolymer, linker-modified HA is combined with a biopolymer-forming solution, e.g. one or more monomers that form the desired biopolymer, in a single pot under conditions suitable to result in formation of an HA-containing biopolymer. As one of skill in the art will appreciate, the conditions required to form an HA-containing biopolymer may vary with reactants used including the biopolymer-forming monomers and the linker-modified HA. Linker-modified HA is combined with biopolymer-forming monomers in a relative amount in the range of about 1-5%. To initiate polymerization of the biopolymer-forming monomers, an initiator is added to the solution with mixing. A suitable initiator may include, for example, benzoyl peroxide, DMPA and irgacure initiators. The initiator is generally added to the solution in solvent-diluted form (e.g. 1-50% by weight, depending on the initiator, in a solvent such as THF or an alcohol such as methanol, isopropanol and ethanol, also depending on the initiator). The solution is subjected to polymerization conditions, such as exposure to heat or light, for an amount of time sufficient to result in polymerization, e.g. about 15 minutes to about 48 hours. Preferably, polymerization time is about 30-60 minutes.

The resulting hyaluronic acid-containing biopolymers in accordance with the present invention contain no more than about 5 wt % linker-modified HA, preferably no more than about 2 wt % linker-modified HA, for example, no more than about 1 wt %, such as between about 0.1 and 0.5 wt %.

In another aspect of the invention, higher molecular weight HA, with a molecular weight of between about 30,000 to 200,000 kDa, and more preferably between about 100,000 to 200,000 kDa, without functionalization (e.g. the HA is not modified to include a linking agent), is combined with a biopolymer-forming solution using the same one-pot method as used with the linker-modified HA. In this aspect, the HA is not linked or tethered to the biopolymer and can ultimately be released from the biopolymer providing access to the HA wetting agent over time, for example, over a period of at least about 7 days, preferably over a period of about 14 days, and more preferably over a period of at least about 20-30 or longer.

The present one-pot method of preparing a hyaluronic acid-containing biopolymer advantageously provides an efficient method of preparing a biopolymer with desirable characteristics.

The hyaluronic acid (HA)-containing biopolymers of the present invention exhibit increased mobility of the HA within the biopolymer, and release to yield increased hydrophilicity (both surface and bulk) (e.g. represented by an advancing water contact angle (AWC) of less than about 50%, more preferably less than 40%, e.g. less than about 30-35%) as compared with known non-HA containing biopolymers. The present biopolymers also exhibited significantly reduced levels of protein adsorption as compared with known biopolymers. For example, protein adsorption may be reduced in an HA-containing biopolymer of the present invention by at least about 10%, preferably by at least about 20% and most preferably by at least about 50%, 60%, 70%, 80% or 90%, as compared with a corresponding unmodified control biopolymer, i.e. a corresponding biopolymer not modified to incorporate HA.

The HA-containing biopolymers are particularly useful for incorporation into devices for use in protein-containing environments to prevent undesirable protein adsorption and/or in environments where reduced surface friction is desirable, for example, in devices such as contact lenses and other lenses used in protein-containing environments, in diagnostic probes and scopes used either in vitro or in vivo and in pace maker leaders.

Embodiments of the invention are described by reference to the following specific examples which are not to be construed as limiting.

### EXAMPLES

### Example 1

### Photo Crosslinked Methacrylated HA Hydrogel Polymer

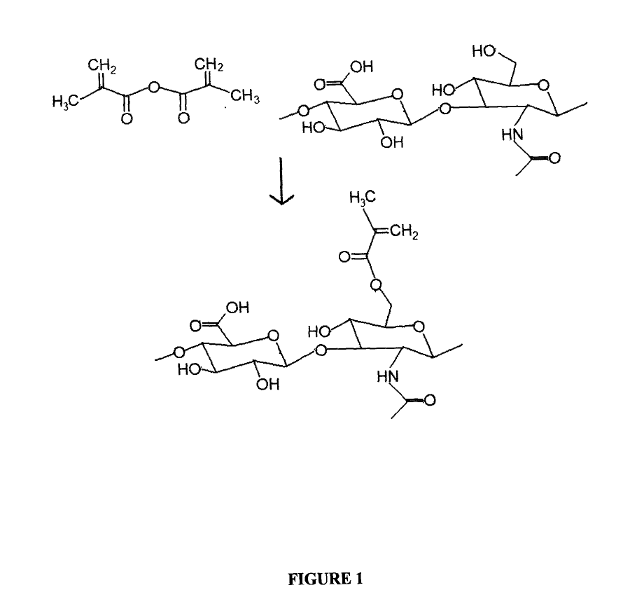

Hyaluronic acid (200 mg) of varying molecular weights was dissolved in 20 ml of MilliQ water (18 mOhm). The HA solution was placed in an ice bath under constant stirring. Methacrylic anhydride (liquid form) was added dropwise to the HA solution. The amount of methacrylic anhydride used was based on the desired molar excess (or degree of methacrylation), and on the molecular weight of the HA chains. A small amount of 5M NaOH was then added dropwise to the solution to bring the pH to 8. This reaction was allowed to proceed for 48 hrs. Throughout this 48 hr period, the ice bath was regularly changed and the pH was adjusted to maintain a pH of 8. The HA solution was dialyzed, using a membrane with a molecular weight cutoff of 3500, against MilliQ water for 48 hrs. The purified HA was lyophilized and then stored at −20° C. until use. The methacrylation reaction, shown schematically in FIG. 1, was confirmed using ¹H-NMR, with an AV-700 NMR spectrophotometer and D₂O as a solvent. ¹H-NMR analysis showed that the HA was successfully methacrylated; with peaks at 6.2 and 5.8 ppm which correspond to the changes that occur in the HA with the addition of methacrylate groups. These peaks were not present in the unmodified HA. These peaks are consistent with HA methacrylation. Methacrylated-HA (Me-HA) was prepared with 20, 10, 5 and 1 molar excess of methacrylic anhydride (referred to herein as 20×, 10×, 5× and 1×).

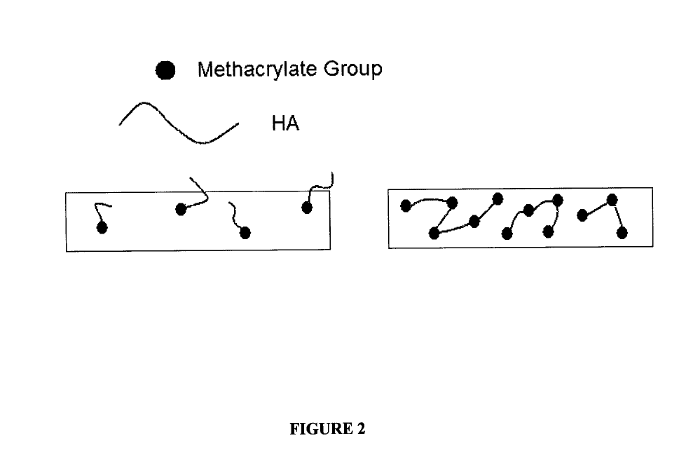

A comparison of high and low methacrylation is depicted in FIG. 2. HEMA monomer (4 g) was passed through a column containing inhibitor remover to remove the 4-methoxyphenol hydroquinone (MEHQ). EGDMA (1% by weight) was added to the HEMA solution. Me-HA (1, 0.5 or 0.25% by weight) was dissolved in 4 ml of MilliQ water. The Me-HA solution was then transferred to the pHEMA mixture. The initiator, benzoyl peroxide (1% by weight in THF), was added to the mixture under constant stirring. A second initiator was required to initiate polymerization of the Me˜HA. This second initiator (33/67 w/w DMPA/methanol) was prepared and added in an amount of about 1% by weight to the pHEMA mixture. The pHEMA solution was then transferred to a Teflon mold and placed in a 400 W UV chamber (Cure Zone 2 Con-trol-cure, Chicago, Ill., USA) for 25 minutes for polymerization at a wavelength of 365 nm. Following polymerization, the formed hydrogels were placed in a 37° C. oven overnight to ensure that the reaction was complete. The hydrogels were then swollen in water for a minimum of 24 hrs to remove unreacted components before being cut into ¼″ discs and stored for analysis.

The model silicone hydrogels (pHEMA/TRIS hydrogels, 90% HEMA, 10% TRIS) were prepared using similar methods as described for the pHEMA hydrogels. The monomers were passed through 2 separate columns containing inhibitor remover to remove MEHQ and mixed in an appropriate ratio. EGDMA (5% by weight) was added to the mixture. Me-HA (4.7 or 5.1 kDa, 0.25% by weight) was added to the mixture under constant stirring. Once the Me-HA was dissolved, the initiators, Irgacure (0.5% by weight) and DMPA (1% by weight) were added to the monomer mixture. The mixture was then transferred to a Teflon mold and the reaction proceeded as above. DMAA/TRIS hydrogels (50% DMAA, 50% TRIS) were prepared using the same methods as pHEMA/TRIS with the same amounts of EGDMA and initiators. In this case, prior to the addition of the initiator, methacrylic acid was passed through a column containing MEHQ and then 1.7% by weight was added to the solution. The composition of the resulting polymers based on the mass of components added to the mixture is shown in the table below.

TABLE 1

| | Amount | Molecular Weight | |
|---|---|---|---|
| Material | (wt %) | (kDa) | Methacrylation |
| pHEMA | 0.25 | 132 | 20 |
| pHEMA | 1.0 | 132 | 20 |
| pHEMA | 0.25 | 4.7 | 20 |
| pHEMA | 0.25 | 5.1 | 5 |
| pHEMA | 0.25 | 5.1 | 1 |
| pHEMA/TRIS | 0.25 | 4.7 | 20 |
| pHEMA/TRIS | 0.25 | 5.1 | 10 |
| pHEMA/TRIS | 0.25 | 5.1 | 5 |
| pHEMA/TRIS | 0.25 | 5.1 | 1 |
| DMAA/TRIS | 0.25 | 4.7 | 20 |
| DMAA/TRIS | 0.25 | 5.1 | 5 |
| DMAA/TRIS | 0.25 | 5.1 | 1 |

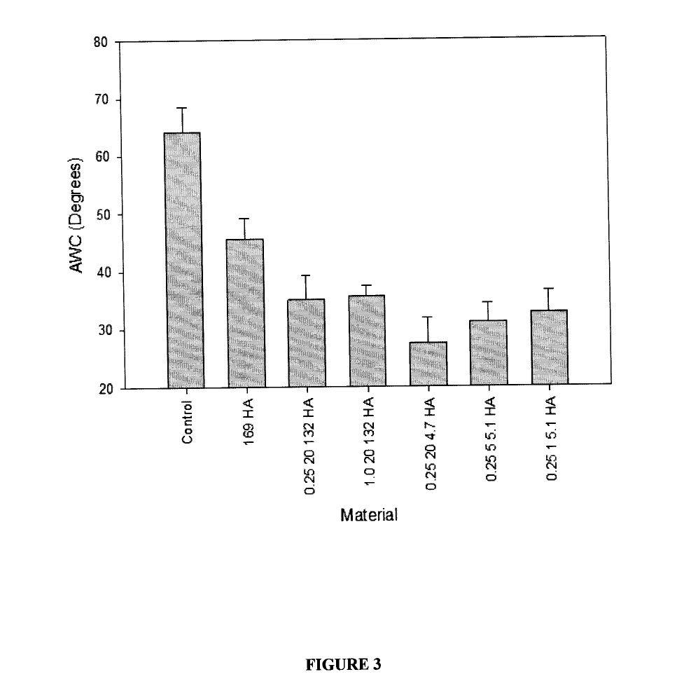

Surface Hydrophilicity/Hydrophobicity: The hydrophilicity of the hydrogel surfaces with and without the internal HA wetting agent was assessed by measuring advancing water contact angles using the sessile drop technique (Rame-Hart NRL 100-00 goniometer). The hydrogels were swollen in PBS for a minimum of 24 hrs prior to making the measurements. The hydrogels were removed from PBS, placed on a microscope slide and then blotted lightly with a Kimwipe to remove excess PBS present on the surface. A 3-5 μl drop of MilliQ water was placed on the surface and the advancing water contact angle was measured. Advancing water contact angle measurements with the modified pHEMA hydrogels showed that the incorporation of methacrylated HA results in a significant reduction in advancing water contact angles (p<0.00002) (FIG. 3). The hydrogels containing 132 kDa Me-HA were compared to hydrogels containing 169 kDa HA loaded using conventionally methods. It was found that the materials containing Me-HA had a more hydrophilic surface (p<0.0008). Furthermore, when the hydrogels containing the 4.7 or 5.1 kDa Me-HA were compared to the conventionally loaded 169 kDa HA-modified materials, the Me-HA hydrogels were also found to be more hydrophilic than conventionally-loaded HA hydrogels (p<0.0002). Additionally, lower molecular weight HA led to lower advancing water contact angles compared with higher MW Me-HA (p<0.0054) when the amount of HA and degree of methacrylation were held constant. Although the methacrylation, and/or amount of Me-HA were different, the hydrogels containing 5.1 kDa HA with 5× methacrylation were also more hydrophilic than either hydrogel containing 132 kDa Me-HA (p<0.05). It was found that increasing the amount of Me-HA polymerized with the system did not have a significant effect on surface hydrophilicity (p>0.38). As well, decreasing the degree of methacrylation from 20 to 5 led to significant increases in the contact angles (p<0.01). This result was somewhat unexpected as decreased methacrylation would be expected to improve hydrophilicity given that the less sterically hindered structure should allow migration of the HA to the surface.

Thus, methacrylated HA can be used to increase surface hydrophilicity of pHEMA hydrogels.

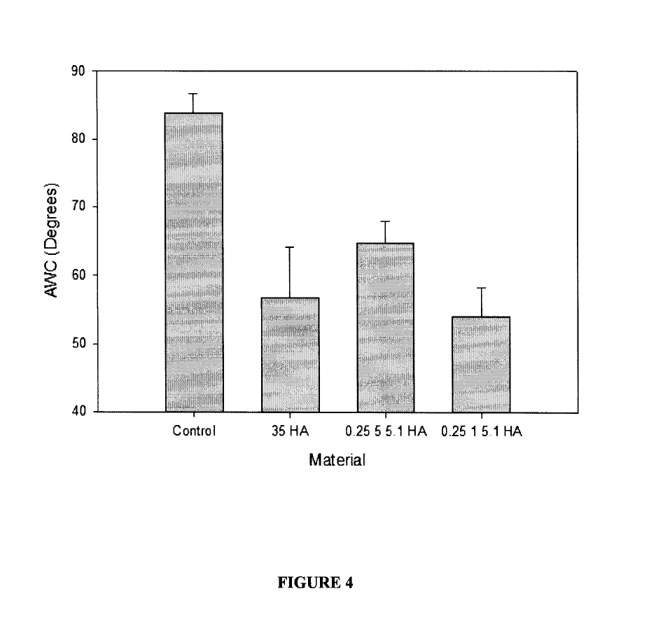

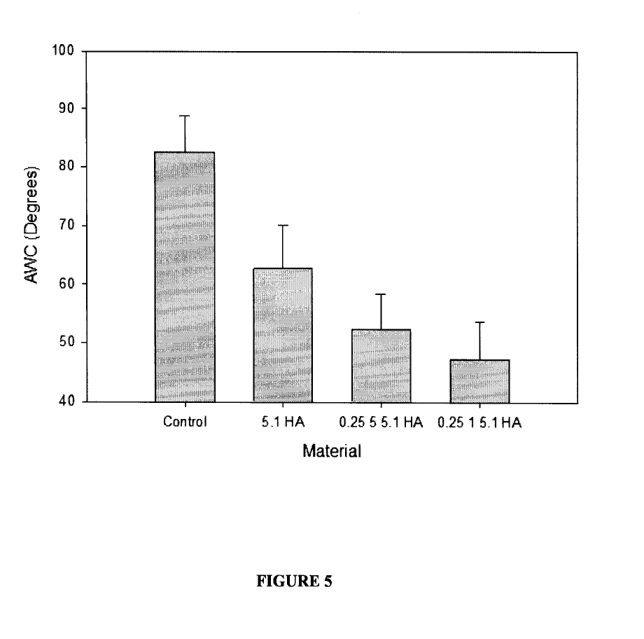

The presence of methacrylated HA as an internal wetting agent also reduced advancing water contact angles in pHEMA/TRIS (p<0.000016) (FIG. 4) and DMAA/TRIS (p<0.000006) (FIG. 5) hydrogels. In these materials, the molecular weight of HA (5.1 kDa) and the amount of HA (0.25 wt %) was held constant based on the results with the pHEMA gels and the degree of methacrylation was varied (5 vs. 1). In pHEMA/TRIS hydrogels, decreasing the degree of methacrylation from 5 to 1 improved hydrophilicity (p<0.001). Although the molecular weight is different, when compared to conventionally loaded 35 kDa HA, the materials containing the Me-HA with the lower degree of methacrylation had a similar contact angle (p>0.25). In the DMAA/TRIS hydrogels, the degree of methacrylation had no effect on the contact angle (p>0.09). When compared to hydrogels with conventionally loaded 5.1 kDa HA however, the materials containing the Me-HA were found to be more hydrophilic (p<0.0006).

Equilibrium Water Content: The effects of HA on the equilibrium water content (EWC) of these hydrogels was assessed by comparing the mass of hydrogels dried for a minimum of 24 hrs (the dry mass) with that of the same gel following swelling in MilliQ water at 20° C. for a minimum of 48 hrs (the wet mass). In the latter case, the hydrogels were gently blotted with a Kimwipe to remove excess water from the surface prior to determining the mass.

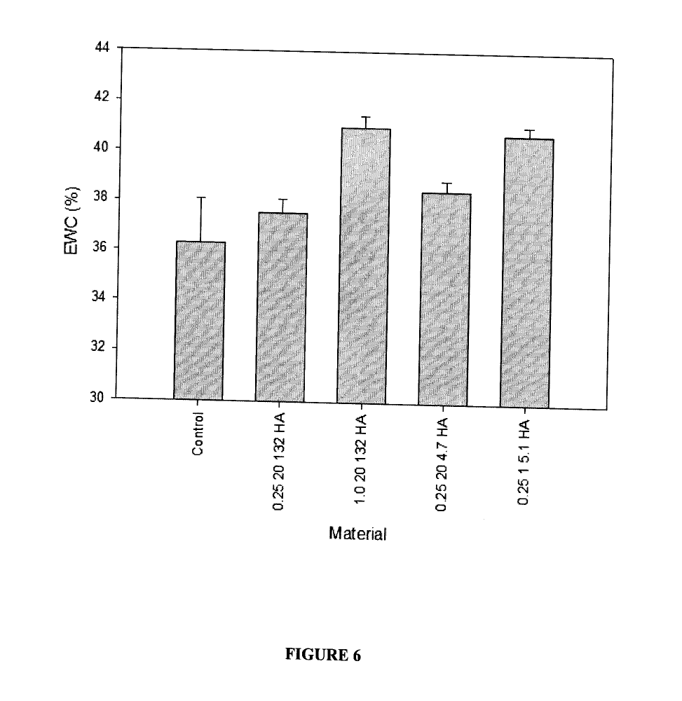

The EWC was calculated for pHEMA hydrogels with varying molecular weights of HA, degrees of methacrylation and amounts of Me-HA added (FIG. 6). Only the hydrogels containing 1.0 wt % 132 kDa HA with 20× methacrylation (p<0.022) and 0.25 wt % 5.1 kDa HA with 1× methacrylation (p<0.024) showed a higher EWC than the controls. It was also found that increasing the amount of HA added to the hydrogel (p<0.0000003), decreasing the molecular weight of HA (p<0.0052) and decreasing the degree of methacrylation (p<0.0000013) resulted in an increase in the EWC. Not surprisingly, increasing the amount of Me-HA in the hydrogels increases the EWC presumably due to the fact that the presence of the additional hydrophilic component counteracts the effect of increased crosslinking from the methacrylate groups. The increase in swelling corresponding to the decreased methacrylation is likely due to less crosslinking. These results indicate that it is possible to tailor, to some extent, the nature of the materials to obtain appropriate EWC and surface hydrophilicity properties.

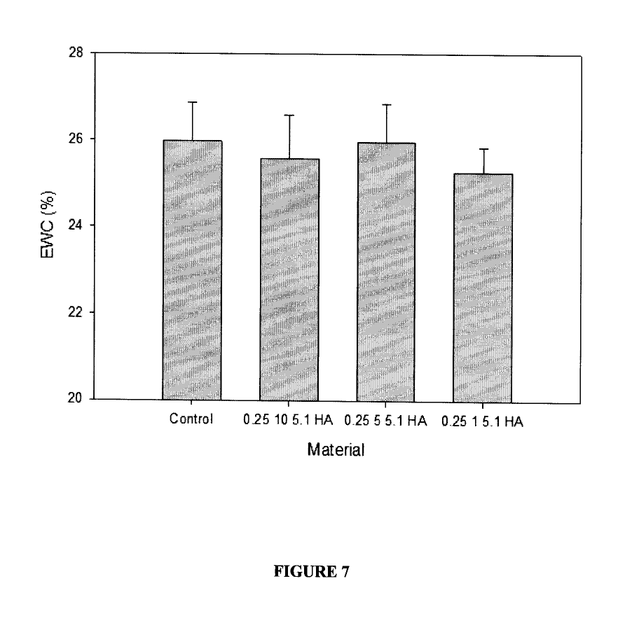

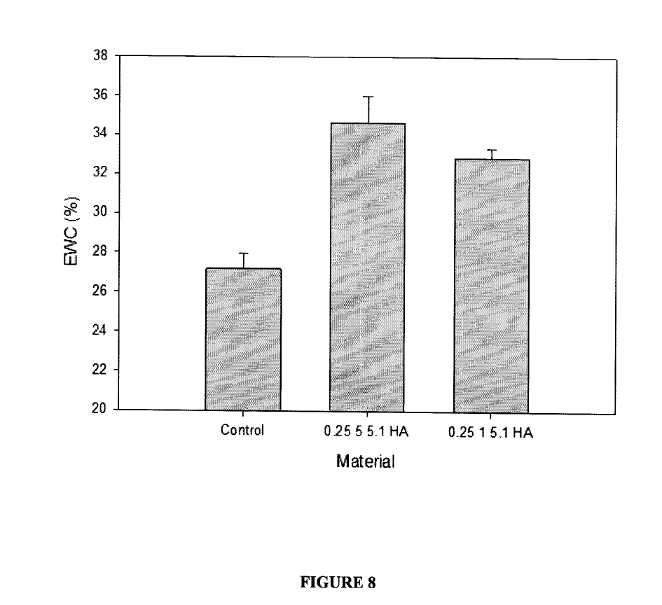

For the model silicone hydrogels, the EWC was calculated for materials containing 0.25 wt % 5.1 kDa HA with varying degrees of methacrylation. As shown in FIG. 7, neither the incorporation of Me-HA (p>0.15) nor changing the degree of methacrylation (p>0.06) was found to significantly impact the EWC in the pHEMA/TRIS gels. However, in the DMAA/TRIS model silicone materials, there was a significant increase in the EWC noted with the addition of Me-HA as shown in FIG. 8 (p<0.000003). Decreasing the degree of methacrylation was shown to decrease EWC (p<0.011). The silicone-based materials have a lower EWC than pHEMA hydrogels; however, the presence of MAA in the DMAA/TRIS hydrogels may combine with the Me-HA to overcome the increased crosslinking and result in an increase in the EWC.

Attenuated Total Reflectance—Fourier Transform Infrared Spectroscopy (ATR-FTIR): ATR-FTIR scans were performed on pHEMA hydrogels containing Me-HA (132 kDa, 0.25% by weight, 20× molar excess), using a Thermo Scientific Nicolet 6700 FTIR spectrophotometer (ThermoFisher, E. Grinstead, UK) to confirm the addition of the Me-HA. Scans were also performed on control pHEMA hydrogels and those containing 132 kDa HA. Prior to scanning the samples, a background reading was taken for each sample. Samples were scanned over a range of 400-4000 cm⁻¹ using a zinc selenide window. The results of the FTIR-ATR scans showed that there were no differences between the control pHEMA and the pHEMA hydrogels containing conventionally loaded 132 kDa HA. However, a scan of the pHEMA hydrogel containing Me-HA showed a peak at 1148 cm⁻¹ that was not evident in the other scans. Peaks at or near this wave number are associated with hydroxyl groups. The HA-methacrylation reaction attaches the methacrylate group to the HA hydroxyl group resulting in this change in the spectra at this wave number. These results indicate that the Me-HA is present in the pHEMA hydrogels

X-Ray Photoelectron Spectroscopy (XPS): XPS analysis was performed on pHEMA hydrogels, controls, hydrogels containing 132 kDa Me-HA (0.25% by weight, 20× molar excess), and the silicone hydrogels (controls and those containing 5.1 kDa Me-HA (0.25% by weight, 1× molar excess)) using a Thermo Scientific Theta Probe XPS Spectrometer (ThermoFisher, E. Grinstead, UK). Both low and high resolution (C1s) scans were performed on these materials to examine changes in surface chemistry with the addition of Me-HA. The scans were performed at take-off angles of 30, 50 and 70 degrees relative to the normal. XPS analysis revealed changes in the pHEMA hydrogels occurring with the addition of Me-HA. These changes were evident in both the low resolution survey scans and high resolution C1s spectra. The low resolution scans revealed an increase in the atomic percentage of carbon, a decrease in oxygen and an increase in nitrogen in the HA-containing materials compared to the control for all three take-off angles, with the exception of a nitrogen increase at 70 degrees. The presence of the nitrogen is indicative of the presence of HA in the materials. Low levels of N1s in the control materials are thought to be the result of contamination. The high-resolution scan at a take-off angle of 30 degrees showed an increase in carbon-carbon bonding at 285 eV with the addition of HA. The scan at 50 degrees showed an increase at 285 eV and a decrease at 289 eV. The greatest changes however were noted in the scan at 70 degrees, with a decrease at 285 eV, an increase at 286.6 eV and a slight decrease at 289 eV.

XPS also revealed changes with the addition of Me-HA in both pHEMA/TRIS and DMAA/TRIS hydrogels. In pHEMA/TRIS hydrogels, the low resolution scans revealed an increase in the atomic percentage of carbon and a decrease in oxygen at all three take-off angles. The Me-HA containing materials also showed an increase in silicone at 30 and 50 degrees and an increase in nitrogen at 50 and 70 degrees. As with the pHEMA hydrogels, this increase in nitrogen is indicative of the presence of HA. The high resolution C1s scans revealed a decrease in carbon-carbon bonding at 285 eV, an increase at 285.7 eV and a decrease at 289 eV at all three contact angles. There were also decreases at 286.6 eV at 30 and 50 degrees with an increase at 70 degrees in the HA materials. The increase at 285.7 eV is indicative of an increase in C—N bonding. HA contains C—N bonding so this increase is indicative of the presence of HA. In the DMAA/TRIS hydrogels, the low resolution scans revealed a decrease in O1s at all three take-off angles in the Me-HA material. The Me-HA material had a decrease in O1s at 30 degrees but had increases at 50 and 70 degrees compared to the control. At 30 and 50 degrees, the Me-HA material had increased Si2p and decreased N1s. The N1s increased at 70 degrees. In the high resolution scans, at all three take-off angles, the Me-HA-containing material showed a decrease in C—C bonding at 285 eV, an increase at 285.5 eV, and decreases at 286.6 and 288 eV. The Me-HA material also showed an increase at 289 eV. As seen with the pHEMA/TRIS hydrogels, this increase at 285.5 is associated with C—N bonding and indicates the presence of HA. The binding energy at 289 eV is associated with carboxylic acid groups which is also indicative of the presence of Me-HA, as HA contains carboxylic acid groups.

Lysozyme Sorption: Radiolabeled lysozyme (125-I), prepared using the iodine monochloride (ICI) method as described previously was used to determine lysozyme sorption to the various materials. Labeled lysozyme was passed through columns packed with AG 1-X4 (Bio-Rad, Hercules, Calif.) to remove any free iodide. The columns were then washed with phosphate buffered saline (PBS, pH 7.4) to ensure that all of the labeled lysozyme had been collected. The amount of free iodide was determined using trichloroacetic acid (TCA) precipitation; this amount was typically less than 3%.

Lysozyme loading solutions were prepared using a 2 mg/ml solution of lysozyme in PBS containing 2% radiolabeled lysozyme. The conventional and silicone hydrogels were incubated in this lysozyme solution (2 ml per sample) at 37° C. for 2 hrs and 24 hrs, respectively. Different incubation periods were selected since silicone-based materials have longer wear periods than conventional materials and conventional materials typically sorb more lysozyme in a given time period than silicone hydrogels. Following incubation, the hydrogels were rinsed in PBS (3 times, 5 minutes) to remove loosely bound protein and blotted dry with a Kimwipe. A Wizard 3 1480 Automatic Gamma Counter (Perkin Elmer) was used to determine the radioactivity of the samples with the amount of lysozyme quantified using a standard curve.

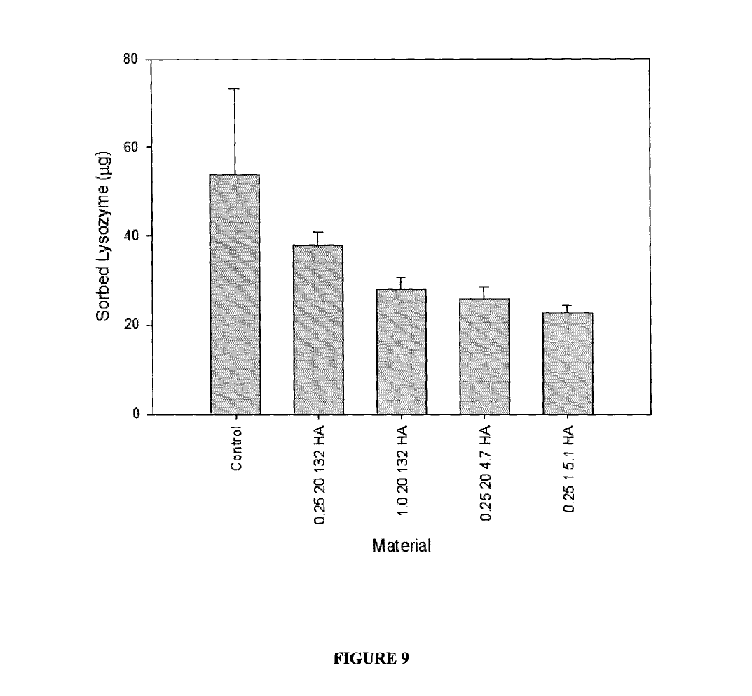

The results, shown in FIG. 9, demonstrate that the presence of Me-HA significantly decreased lysozyme sorption in all cases (p<0.005), with the HA-containing materials sorbing only 42-70% of that of the control. It was also found that increasing the amount of Me-HA (p<0.00000001), decreasing the molecular weight of HA (p<0.00000001) and decreasing the degree of methacrylation (p<0.002) significantly reduced lysozyme sorption. Additionally, combining these effects with a molecular weight decrease from 132 to 5.1 kDa, and a methacrylation decrease from 20 to 1, lysozyme sorption was significantly decreased (p<0.000000000003). The increased mobility resulting from lower molecular weight HA and lower degrees of methacrylation appear to be most desirable.

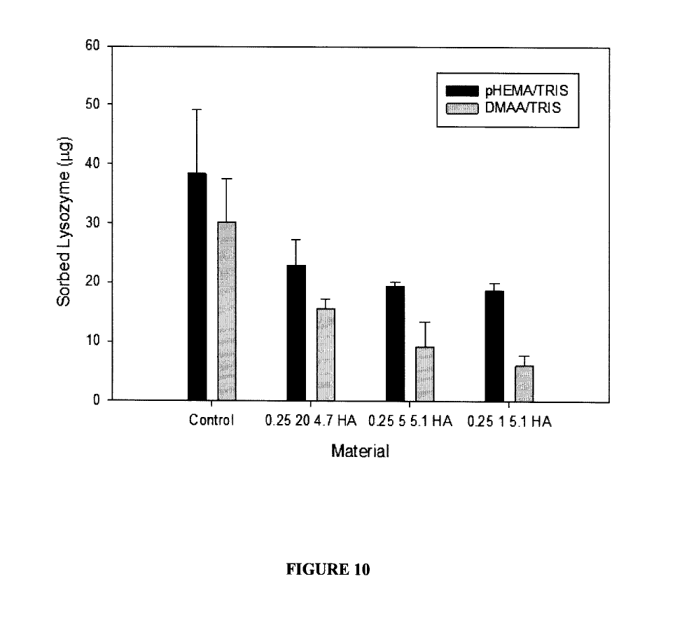

As shown in FIG. 10, with the silicone hydrogels, the incorporation of the Me-HA also decreased lysozyme sorption with both pHEMA/TRIS hydrogels (p<0.0008) and DMAA/TRIS gels (p<0.003) showing lower levels of protein adsorption. Increased mobility of the Me-HA with decreased degree of methacrylation in the gels led to a decrease in the levels of protein associated with the gels.

### Example 2

### Releasable HA Hydrogel Polymers

HEMA monomer (4 g) was passed through a column containing inhibitor remover for the removal of 4-methoxyphenol hydroquinone (MEHQ). EGDMA (1% by weight) was added to the HEMA solution. HA (0.5% by weight, 35 or 910 kDa) was dissolved in 4 ml of MilliQ water. The HA solution was then added to the pHEMA mixture. The initiator, benzoyl peroxide (1% by weight), was added to the pHEMA mixture under constant stirring. Some of the pHEMA solution was transferred to small plastic molds (100 μl each). These samples were used to monitor HA release. The remaining amount of pHEMA solution was transferred to an aluminum mold. This portion of the pHEMA solution was used to monitor lysozyme sorption. Both parts were placed in a 400 W UV chamber (Cure Zone 2 Con-trol-cure, Chicago, Ill., USA) for 25 minutes for polymerization. Following polymerization, the formed hydrogels were placed in a 37° C. oven overnight to ensure that the reaction was complete.

Similar methods were used to prepare the silicone hydrogels. For pHEMA/TRIS hydrogels (90% HEMA, 10% TRIS), the two separate columns were used to remove MEHQ from the monomers. EGDMA (5% by weight) was added to the monomer mixture. HA (5.1 kDa, 0.25% by weight) was added to the mixture under constant stirring. Once the HA appeared to be dissolved, the initiator, Irgacure (0.5% by weight) was added to the monomer mixture. The mixture was then transferred to small plastic molds and aluminum molds and the reaction steps were the same as for pHEMA hydrogels. DMAA/TRIS hydrogels (50% DMAA, 50% TRIS) were prepared using the same methods and amounts of EGDMA and Irgacure as pHEMA/TRIS.

Hyaluronic Acid Release: Hydrogels were removed from the plastic molds and then weighed to allow for release to be normalized to weight. The dried hydrogels were placed in 1 ml of phosphate buffered saline (PBS) (pH=7.4) at 37° C. in a rotating water bath. At various time intervals, samples were taken and PBS was replenished. The released HA was determined using a UV spectrophotometer with readings taken at 280 nm. Readings for DMAA/TRIS hydrogels were taken at 231 nm. These UV readings were then converted to a quantity of HA by using a CTAB assay.

Lysozyme Sorption: Lysozyme was labeled with iodine 125 (125-I) using the iodine monochloride method (ICI). Following the labeling reactions, the lysozyme was passed through columns packed with AG 1-X4 (Bio-Rad, Hercules, Calif.) to try and eliminate free iodide. These columns were then rinsed with PBS to ensure that there was no labeled lysozyme remaining in the tubes. The percentage of free iodide was determined using a trichloroacetic acid (TCA) test and was typically less than 3%.

The hydrogel samples (¼ inch in diameter) for lysozyme sorption were placed in PBS under the same conditions as the samples for monitoring release. At the same time intervals as for the release samples, hydrogels were removed from PBS and then dried for a minimum of 24 hrs. The PBS was replenished as it was with the release samples. These dried hydrogels were incubated in lysozyme solutions (2% labeled protein, 2 mg/ml, pH=7.4) at 37° C. for 2 hrs and 24 hrs for pHEMA and silicone hydrogels, respectively. Following incubation, the hydrogels were rinsed 3 times for 5 minutes in PBS. They were then blotted dry with a Kimwipe. A Wizard 3 1480 Automatic Gamma Counter (Perkin Elmer) was used to count the radioactivity of the samples and these radioactive counts were converted to a protein amount using a standard curve.

Release Studies for pHEMA Hydrogels: The results of the release study showed that imprinted 35 kDa and 910 kDa HA could be released from pHEMA hydrogels for at least 14 days following a burst. This release is a significant improvement when compared with standard uptake and release. The release of 35 kDa HA decreased lysozyme sorption for up to 12 days (p<0.0002), with the HA-releasing hydrogels sorbing approximately 12-31% relative to the control. The mean amount of lysozyme deposited during the 12 day HA release was 8.57±2.89 μg. The release of 910 kDa HA decreased lysozyme sorption for up to 14 days (p<0.002), with the HA-releasing hydrogels sorbing approximately 25-55% relative to the control. The mean amount of lysozyme deposited during the 14 day release was 15.76±3.65 μg. The smaller 35 kDa HA was more effective in reducing lysozyme sorption than 910 kDa HA (p<0.00004).

Release Studies for pHEMA/TRIS Hydrogels: The results of the release study showed that imprinted 5.1 kDA HA could be released from pHEMA/TRIS hydrogels for 28 days following a burst. The release of HA decreased lysozyme sorption, with the exception of the 20 day sample, for the 28 days included in the study (p<0.05), with the HA-releasing materials sorbing approximately 26-67% relative to the control. The mean amount of lysozyme deposited during the HA release was 13.57±3.14 μg.

Release Studies for DMAA/TRIS Hydrogels: The release of HA from the hydrogel was extended beyond 28 days and the results showed that imprinted 5.1 kDa HA could be released from DMAA/TRIS hydrogels for 49 days following a burst. The mean amount of lysozyme sorbed during the release was 2.32±0.36 μg, which was significantly less than the mean amount taken up by the pHEMA/TRIS hydrogels during the release.

We claim:

1. A hyaluronic acid-containing biopolymer, wherein the hyaluronic acid is modified to incorporate a linking agent that links the HA to the biopolymer, wherein the degree of HA modification by the linking agent is in a range of about 1-5, preferably between 2-3.

2. The biopolymer of claim 1, wherein the hyaluronic acid has a molecular weight of about 1-200 kDa.

3. The biopolymer of claim 2, wherein the hyaluronic acid has a molecular weight of about 1 to 40 kDa.

4. The biopolymer of claim 1, wherein the biopolymer is selected from the group consisting of acrylic-based polymers, polyurethanes, silicone polymers, polyvinyl alcohol and collagen.

5. The biopolymer of claim 4, wherein the biopolymer is selected from the group consisting of methyl methacrylate, poly (hydroxyethyl methacrylate) (pHEMA), poly N-isopropyl acrylamide, polyacrylic acid, copolymers of methacryloxy propyl tris (trimethylsiloxy) silane (TRIS) and acrylic-based polymers comprising various amounts of TRIS varying from about 1% to 99% TRIS.

6. The biopolymer of claim 1, wherein the linking agent is any compound that can be activated by light in the presence of a polymerizing initiator.

7. The biopolymer of claim 6, wherein the linking agent is selected from the group consisting of acrylic anhydride, methacrylic anhydride and methacrylate.

8. The biopolymer of claim 1, wherein the linker-modified HA is present in a relative amount in the range of about 0.1-5% by weight.

9. The biopolymer of claim 8, wherein the linker-modified HA is present in a relative amount in the range of about 0.1 and 0.5 wt %.

10. The biopolymer of claim 1, which exhibits a hydrophilicity represented by an advancing water contact angle (AWC) of less than about 50%, more preferably less than 40%, and most preferably less than about 30%.

11. The biopolymer of claim 1 which exhibits a protein desorption of about 10% less than a non-HA-containing biopolymer, more preferably of less than about 50%.

12. A biopolymer containing hyaluronic acid having a molecular weight in the range of about 30,000-200,000 kDa, wherein the hyaluronic acid is releasably contained within the biopolymer.

13. The biopolymer of claim 12, wherein the hyaluronic acid is released over a period of at least about 14 days.

14. The biopolymer of claim 12, which exhibits less than 50% protein sorption as compared to a non-HA-containing biopolymer.

15. A one-step method of making hyaluronic acid-containing biopolymer comprising admixing HA with a biopolymer-forming solution under conditions suitable to effect polymerization.

16. The method of claim 15, wherein the HA has a molecular weight of about 1 to 40 kDa.

17. The method of claim 16, in the presence of a linking agent.

18. The method of claim 17, wherein the linking agent is selected from the group consisting of acrylic anhydride, methacrylic anhydride and methacrylate.

19. The method of claim 15, conducted in the presence of an initiator.

20. The method of claim 15, wherein the HA has a molecular weight in the range of about 100,000 to 200,000 kDa.
